(19) United States
(12) Patent Application Publication
(10) Pub. No.: US 2008/0158105 A1
(43) Pub. Date: Jul. 3, 2008

(54) PLASMA DISPLAY PANEL AND METHOD OF MANUFACTURING THE SAME

(75) Inventors: Byoung-min Chun, Suwon (KR); Kwang-sik Lee, Suwon (KR); Won-ju Yi, Suwon (KR); Kyoung-doo Kang, Suwon (KR); Yong-shik Hwang, Suwon (KR); Tae-seung Cho, Suwon (KR); Seok-gyun Woo, Suwon (KR); Jong-woo Choi, Suwon (KR); Seong-gi Choo, Suwon (KR); Young-do Choi, Suwon (KR); Jae-ik Kwon, Suwon (KR); Hyun-min Son, Suwon (KR)

Correspondence Address: CHRISTIE, PARKER & HALE, LLP, PO BOX 7068, PASADENA, CA, 91109-7068, US

(73) Assignee: SAMSUNG SDI CO., LTD., Suwon-si (KR)

(21) Appl. No.: 11/858,833

(22) Filed: Sep. 20, 2007

(30) Foreign Application Priority Data
Jan. 2, 2007 (KR) 10-2007-0000366

(51) Int. Cl. G09G 3/28

(52) U.S. Cl. 345/71

(57) ABSTRACT

A plasma display panel including: a first substrate; a plurality of first electrodes and a plurality of second electrodes, the first and second electrodes being disposed in parallel on the first substrate; a first dielectric surrounding the first electrodes and the second electrodes and connecting the first electrodes and the second electrodes; a passivation layer on the first dielectric and on the first electrodes and the second electrodes; a second substrate facing the first substrate; a plurality of third electrodes on the second substrate and crossing the first electrodes and the second electrodes; and a second dielectric on the third electrodes.

### CROSS-REFERENCE TO RELATED APPLICATION

This application claims priority to and the benefit of Korean Patent Application No. 10-2007-0000366, filed on Jan. 2, 2007, in the Korean Intellectual Property Office, the entire content of which is incorporated herein by reference.

### BACKGROUND

1. Field of the Invention

The present invention relates to a plasma display panel and a method of manufacturing the plasma display panel.

2. Discussion of Related Art

A plasma display panel (PDP) is a flat panel display device for displaying characters and/or images by allowing a fluorescent material to emit light with plasma generated when gas is discharged. As compared with a liquid crystal display (LCD) or a field emission display (FED), the plasma display panel has higher brightness and higher light emitting efficiency, and therefore the plasma display panel has been in the limelight as a display device capable of replacing a cathode ray tube (CRT).

A plasma display panel can be classified as a direct current (DC) type plasma display panel or an alternating current (AC) type plasma display panel according to the structure of its pixels arranged in the form of a matrix and its waves of drive voltages. In the DC type plasma display panel, all electrodes are exposed to a discharge space so that charges can be directly moved between the electrodes. In the AC type plasma display panel, one or more electrodes are surrounded by a dielectric so that charges cannot be directly moved between corresponding electrodes.

Further, a discharge structure of the plasma display panel can be classified into an opposition discharge structure or a surface discharge structure according to the configuration of electrodes for discharging electricity. In the opposition discharge structure, an address discharge for selecting a pixel and a sustain discharge for sustaining the discharge are generated between a scan electrode (the positive pole) and an address electrode (the negative pole). By contrast, in the surface discharge structure, an address discharge for selecting a pixel is generated between an address electrode and a scan electrode, which cross each other, and a sustain discharge for sustaining the discharge is generated between the scan electrode and a sustain electrode.

FIG. 1 is a perspective schematic view of a conventional plasma display panel and FIG. 2 is a cross-sectional schematic view showing a pixel of the plasma display panel of FIG. 1. The plasma display panel of FIGS. 1 and 2 is an electrode surface light emission type.

Referring to FIGS. 1 and 2, a plurality of sustain electrodes 12a and a plurality of scan electrodes 12b covered by a dielectric 15 and a passivation layer 16 are formed in parallel on an upper substrate 11. The sustain electrodes 12a and the scan electrodes 12b include transparent electrodes 13a and 13b formed of indium tin oxide (ITO) and metal electrodes 14a and 14b for increasing conductivity.

A plurality of address electrodes 22 covered by a dielectric 23 are formed on a lower substrate 21. Partition walls 24 are formed on the dielectric 23 between the plurality of address electrodes 22 in parallel to the address electrodes 22 and fluorescent (or phosphorous) layers 25 are formed on both side surfaces of the partition walls 24 and on a surface of the dielectric 23.

The upper substrate 11 and the lower substrate 21 are adhered to each other so that the sustain electrodes 12a and the address electrodes 22, and the scan electrodes 12b and the address electrodes 22 can be perpendicular to each other. A gas for forming plasma is sealed in closed discharge spaces 30 formed by the partition walls 24 to constitute a plurality of pixels.

As mentioned above, in the conventional plasma display panel, the transparent electrode, the metal electrode, the dielectric, and the passivation layer are formed by forming individual layers on the upper substrate 11 and the lower substrate 21 and patterning these individual layers. Then, the upper substrate 11 and the lower substrate 21 are assembled. Therefore, the processes for manufacturing the plasma display panel are complex and the manufacturing cost is high due to use of many materials. Further, since the dielectric 15 and the passivation layer 16 are formed on the upper substrate 11 in the discharge spaces 30, the transmission rate of light emitted from the fluorescent layers 25 is reduced, thereby lowering the light emitting efficiency.

### SUMMARY OF THE INVENTION

Aspects of embodiments of the present invention are directed to a plasma display panel that can simplify its manufacturing process and/or improve its discharge efficiency, and a method of manufacturing the plasma display panel.

An embodiment of the present invention provides a plasma display panel including: a first substrate; a plurality of first electrodes and a plurality of second electrodes, the first and second electrodes being disposed in parallel on the first substrate; a first dielectric surrounding the first electrodes and the second electrodes and connecting the first electrodes and the second electrodes; a passivation layer on the first dielectric and on the first electrodes and the second electrodes; a second substrate facing the first substrate; a plurality of third electrodes on the second substrate and crossing the first electrodes and the second electrodes; and a second dielectric on the third electrodes.

Another embodiment of the present invention provides a method of manufacturing a plasma display panel. The method includes: forming a first electrode, a second electrode, and a bridge connecting the first electrode and the second electrode by patterning a metal sheet; forming a dielectric by oxidizing surfaces of the first electrode and the second electrode to a thickness of the first electrode and the second electrode; bonding the first electrode and the second electrode to a substrate; and forming a passivation layer on the dielectric.

Another embodiment of the present invention provides a method of manufacturing a plasma display panel. The method includes: pattering a metal sheet to form a first electrode, a second electrode, and a bridge connected to the first electrode and the second electrode; oxidizing the first electrode and the second electrode to a thickness of the first electrode and the second electrode to form a dielectric surrounding the first electrode and the second electrode; bonding the first electrode and the second electrode to a substrate; and forming a passivation layer on the dielectric.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective schematic view of a conventional plasma display panel;

FIG. 2 is a cross-sectional schematic view of a portion of the conventional plasma display panel of FIG. 1;

FIG. 3 is a perspective schematic view of a plasma display panel according to an embodiment of the present invention;

FIG. 4 is a cross-sectional schematic view of a portion of the plasma display panel of FIG. 3 according to an embodiment of the present invention;

FIGS. 5A and 5B are plan schematic views of a sustain electrode and a scan electrode according to an embodiment of the present invention;

FIGS. 6A, 6B, 6C, and 6D are cross-sectional schematic views for illustrating a method of manufacturing a plasma display panel according to a first embodiment of the present invention; and

FIGS. 7A, 7B, 7C, and 7D are cross-sectional schematic views for illustrating a method of manufacturing a plasma display panel according to a second embodiment of the present invention.

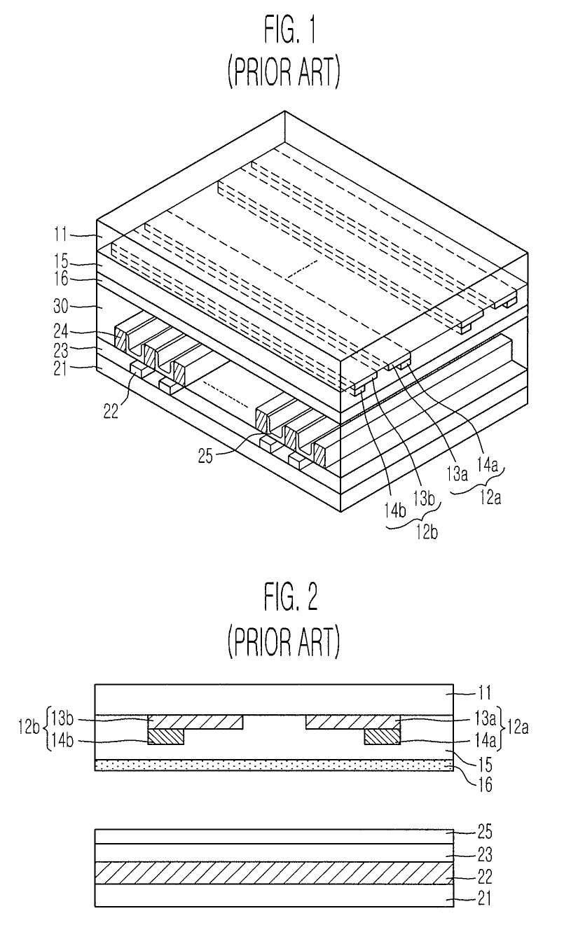

### DETAILED DESCRIPTION

Hereinafter, exemplary embodiments according to the present invention will be described with reference to the accompanying drawings. Here, when one element is described as being connected to another element, one element may be not only directly connected to another element but instead may be indirectly connected to another element via one or more other elements. Also, in the context of the present application, when an element is referred to as being “on” another element, it can be directly on the another element or be indirectly on the another element with one or more intervening elements interposed therebetween. Further, some of the elements that are not essential to the complete description of the invention have been omitted for clarity. Also, like reference numerals refer to like elements throughout.

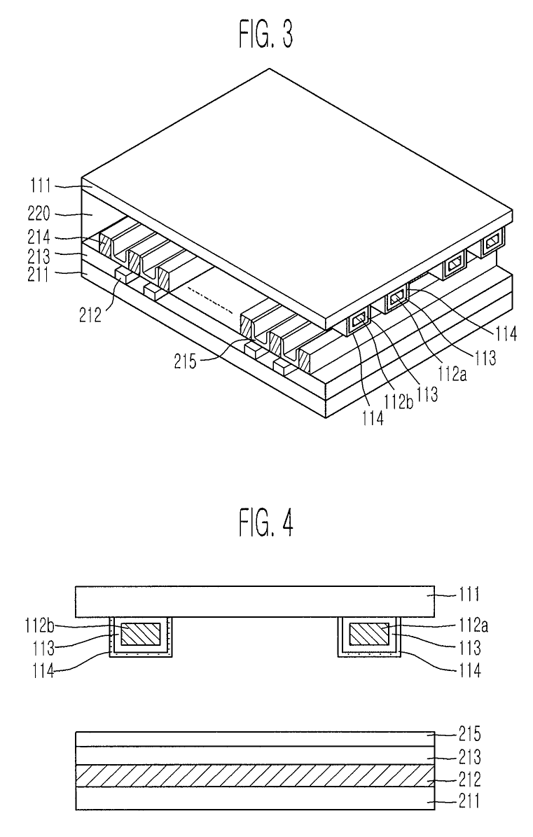

FIG. 3 is a perspective schematic view of a plasma display panel according to an embodiment of the present invention, and FIG. 4 is a cross-sectional schematic view showing a pixel of the plasma display panel of FIG. 3.

Referring to FIGS. 3 and 4, a plurality of sustain electrodes 112a and a plurality of scan electrodes 112b are formed in parallel on an upper (or first) substrate 111. The sustain electrodes 112a and the scan electrodes 112b are surrounded by a dielectric 113 and are connected to each other by the dielectric 113. A passivation layer 114 is formed on the dielectric 113 on the surfaces of the sustain electrodes 112a and the scan electrodes 112b.

A plurality of address electrodes 212 are formed on a lower (or second) substrate 211 so as to cross the sustain electrodes 112a and the scan electrodes 112b, and a dielectric 213 is formed on the address electrodes 212. Partition walls 214 are formed on the dielectric 213 between the address electrodes 212 in parallel to the address electrodes 212 and fluorescent (or phosphorous) layers 215 are formed on both side surfaces of the partition walls 214 and a surface of the dielectric 213.

In one embodiment, the upper substrate 111 and the lower substrate 211 are adhered to each other so that the sustain electrodes 112a and the address electrodes 212, and the scan electrodes 112b and the address electrodes 212 can be perpendicular to each other, thereby forming discharge spaces 220 with the partition walls 214. A gas for forming plasma is sealed in the discharge spaces 220 to constitute a plurality of pixels. Inert mixture gases such as He+Xe, Ne+Xe, and He+Xe+Ne can be used as the gas for forming plasma.

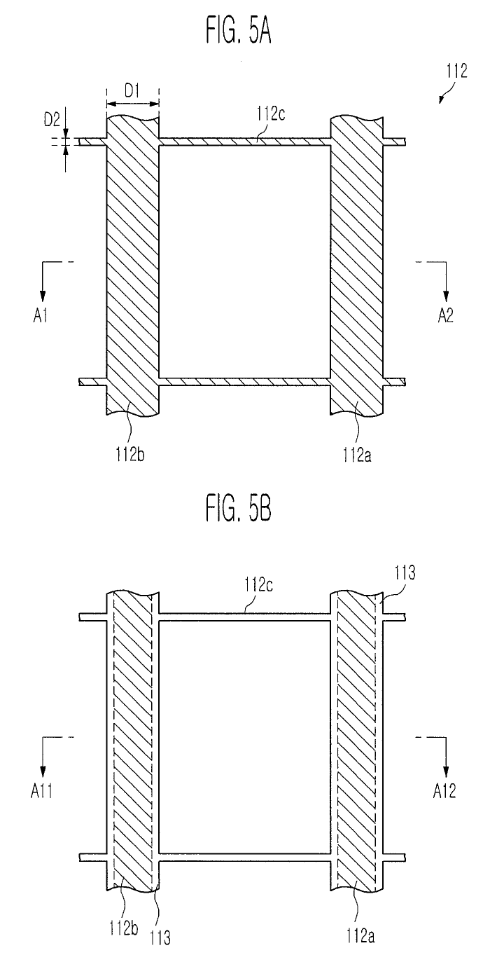

As shown in FIG. 5A, the sustain electrode 112a and the scan electrode 112b are formed of metal sheet(s) 112 such as aluminum sheet(s) of a thickness that may be predetermined and are connected to each other by a bridge 112c of the metal sheet(s) 112. For example, the sustain electrode 112a and the scan electrode 112b disposed in parallel at an interval and the bridge 112c connecting the sustain electrode 112a and the scan electrode 112b can be formed by patterning the metal sheet(s) 112 through photographing and etching processes as shown in FIG. 5A.

The dielectric 113 can be formed to surround the entire surfaces of the sustain electrodes 112a and the scan electrodes 112b or can be formed on remaining surfaces of the sustain electrodes 112a and the scan electrodes 112b except for surfaces opposing the upper substrate 111. The dielectric 113 can be formed of an oxide including metal atoms of the sustain electrodes 112a and the scan electrodes 112b. For example, if the metal sheet 112 patterned as shown in FIG. 5A is oxidized to a thickness that may be predetermined, the surfaces of the sustain electrodes 112a and the scan electrodes 112b are oxidized as shown in FIG. 5B and the dielectric 113 including a metal oxide is formed. Then, as shown in FIG. 5A, if the widths D1 of the sustain electrode 112a and the scan electrode 112b are larger than the width D2 of the bridge 112c and the oxidation process is performed so as to completely oxidize the bridge 112c, the dielectric 113 formed of a metal oxide is formed on the surfaces of the sustain electrode 112a and the scan electrode 112b as shown in FIG. 5B and the bridge is completely changed to an oxide. Therefore, although the sustain electrode 112a and the scan electrode 112b are structurally (or physically) connected to each other by the bridge 112c, the sustain electrode 112a and the scan electrode 112b are electrically insulated (or separated) from each other because the material forming the bridge 112c has been completely changed to an oxide.

According to an embodiment of the present invention, the plasma display panel as described above can be manufactured by the following method.

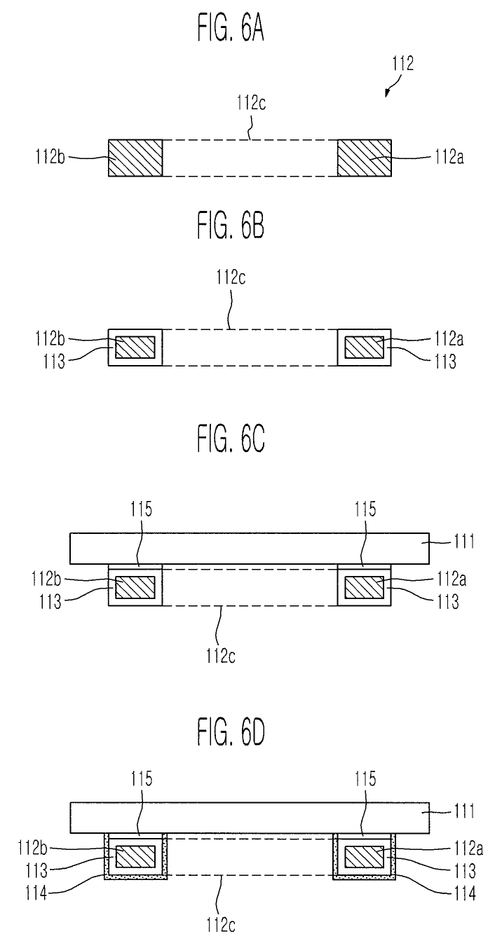

FIGS. 6A to 6D are cross-sectional schematic views for illustrating a method of manufacturing the plasma display panel according to a first embodiment of the present invention and FIGS. 5A and 5B will be referred to again.

Referring to FIGS. 5A and 6A, the sustain electrode 112a and the scan electrode 112b disposed in parallel at an interval, and the bridge 112c connecting the sustain electrode 112a and the scan electrode 112b are formed by patterning the metal sheet 112. In one embodiment, for example, the metal sheet 112 is an aluminum sheet of a thickness that may be predetermined. FIG. 6A is a cross-sectional view taken along the line A1-A2 of FIG. 5A. The sustain electrode 112a, the scan electrode 112b, and the bridge 112c take the form of a sheet and are integrally connected to each other.

Referring to FIGS. 5B and 6B, the surfaces of the sustain electrode 112a and the scan electrode 112b are oxidized to a thickness (that may be predetermined) in an oxidation process to form the dielectric 113 including a metal oxide such as Al₂O₃. Then, if the oxidation process is performed so as to completely oxidize the bridge 112c, the sustain electrode 112a and the scan electrode 112b are structurally connected to each other but are electrically separated from each other. FIG. 6B is a cross-sectional view taken along the line A11-A12 of FIG. 5B.

Referring to FIG. 6C, the sustain electrode 112a and the scan electrode 112b in the form of a sheet integrally connected by the bridge 112c are bonded to the upper substrate 111 using an adhesive 115.

Referring to FIG. 6D, the passivation layer 114 is formed on the dielectric 113 using magnesium oxide etc. In one embodiment, the passivation layer 114 is formed on the dielectric 113 and on the sustain and scan electrodes 112a and 112b.

As mentioned above, in the first embodiment of the present invention, the sustain electrode 112a and the scan electrode 112b, and the bridge connecting the sustain electrode 112a and the scan electrode 112b are formed by patterning the metal sheet 112. Further, after the dielectric 113 is formed by oxidizing the surfaces of the sustain electrode 112a and the scan electrode 112b connected to each other by the bridge 112c, it is bonded to the upper substrate 111 using an adhesive. In this case, since the dielectric 113 surrounds all the surfaces of the sustain electrode 112a and the scan electrode 112b, the dielectric 113 is interposed between the upper substrate 111 and the sustain electrode 112a and the scan electrode 112b.

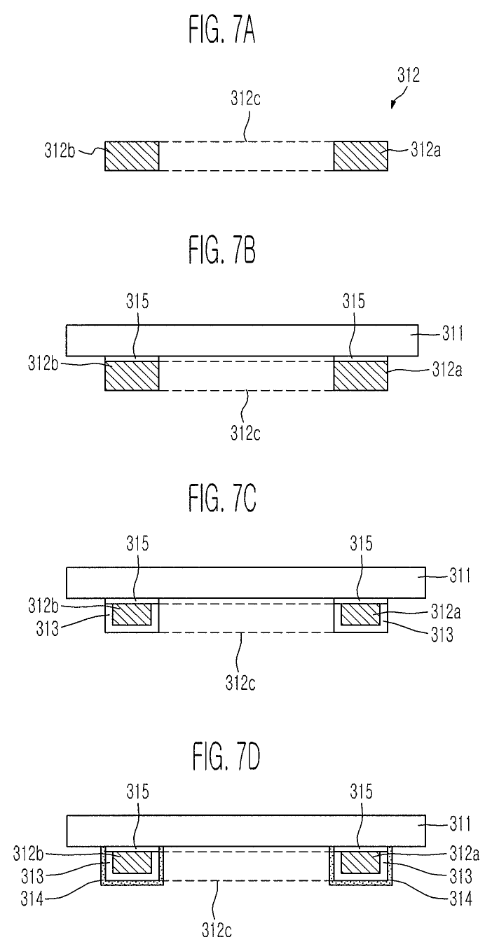

FIGS. 7A to 7D are cross-sectional views for illustrating a plasma display panel formed according to a second preferred embodiment of the present invention.

Referring to FIG. 7A, a sustain electrode 312a and a scan electrode 312b disposed in parallel at an interval, and a bridge 312c connecting the sustain electrode 312a and the scan electrode 312b are formed by patterning a metal sheet 312. In one embodiment, the metal sheet 312 is an aluminum sheet of a thickness that may be predetermined. The sustain electrode 312a, the scan electrode 312b, and the bridge 312c take the form of a sheet and are integrally connected to each other.

Referring to FIG. 7B, the sustain electrode 312a and the scan electrode 312b in the form of a sheet integrally connected by the bridge 312c are bonded to an upper substrate 311 using an adhesive 315.

Referring to FIG. 7C, the surfaces of the sustain electrode 312a and the scan electrode 312b are oxidized to a thickness that may be predetermined in an oxidation process that may be predetermined to form a dielectric 313 including a metal oxide such as Al₂O₃. Then, if the oxidation process is performed so as to completely oxidize the bridge 312c, the sustain electrode 312a and the scan electrode 312b are structurally connected to each other but are electrically separated from each other.

Referring to FIG. 7D, the passivation layer 314 is formed on the dielectric 313 using magnesium oxide (MgO), etc. In one embodiment, the passivation layer 314 is formed on the dielectric 313 and on the sustain and scan electrodes 312a and 312b.

As mentioned above, in the second embodiment of the present invention, after the sustain electrode 312a, the scan electrode 312b and the bridge 312c connecting the sustain electrode 312a and the scan electrode 312b are formed by patterning the metal sheet 312, the electrodes are then bonded to the upper substrate 311 using an adhesive. Further, the dielectric 313 including a metal oxide is formed on the surfaces of the sustain electrode 312a and the scan electrode 312b by performing the oxidation process so that the bridge 312c can be completely oxidized. In this case, since the dielectric 313 is formed only on the remaining surfaces of the sustain and scan electrodes 312a and 312b except for surfaces opposing the upper substrate 311, the dielectric is not interposed between the upper substrate 311 and the sustain electrode 312a and the scan electrode 312b.

In a plasma display panel according to an embodiment of the present invention, an image of a desired gradation is displayed by dividing a unit frame into a plurality of sub-fields and sequentially performing an initialization process, an address process, and a sustain and discharge process in the sub-fields. In the initialization process, the address process, and the sustain and discharge process, drive signals having voltage waves (or predetermined voltage waves) are applied to the sustain electrode, the scan electrode, and the address electrode.

As mentioned above, an embodiment of the present invention forms a scan electrode and a sustain electrode connected by a bridge using a metal sheet, in which a dielectric of a metal oxide is formed on the surfaces thereof. Here, the scan electrode and the sustain electrode in the form of a sheet are bonded to an upper substrate.

According to an embodiment of the present invention, since the number of processes for manufacturing the scan electrode, the sustain electrode, and/or the dielectric is reduced, and the scan electrode and the sustain electrode can be easily assembled; the manufacturing cost can be effectively reduced. Further, in one embodiment, the discharge voltage Vs can be reduced by increasing the opposing surfaces of the scan electrode and the sustain electrode. In addition, the light emitting area can be sufficiently increased (or secured) by increasing the distance between the scan electrode and the sustain electrode. Furthermore, the transmission rate of light is increased by further exposing a substrate of the discharge space, thereby improving discharge efficiency.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a first substrate;
a plurality of first electrodes and a plurality of second electrodes, the first and second electrodes being disposed in parallel on the first substrate;
a first dielectric surrounding the first electrodes and the second electrodes and connecting the first electrodes and the second electrodes;
a passivation layer on the first dielectric and on the first electrodes and the second electrodes;
a second substrate facing the first substrate;
a plurality of third electrodes on the second substrate and crossing the first electrodes and the second electrodes; and
a second dielectric on the third electrodes.

2. The plasma display panel according to claim 1, wherein the first dielectric comprises an oxidized substance, the oxidized substance comprising metal atoms of the first electrodes and the second electrodes.

3. The plasma display panel according to claim 1, wherein the first dielectric comprises oxidized portions of the first electrodes and the second electrodes.

4. The plasma display panel according to claim 1, further comprising:
an adhesive between the first substrate and the first and second electrodes.

5. The plasma display panel according to claim 1, wherein the first electrodes, the second electrodes, and the first dielectric are formed from a same metal sheet.

6. The plasma display panel according to claim 5, wherein the metal sheet comprises aluminum.

7. A method of manufacturing a plasma display panel, the method comprising:
forming a first electrode, a second electrode, and a bridge connecting the first electrode and the second electrode by patterning a metal sheet;
forming a dielectric by oxidizing surfaces of the first electrode and the second electrode to a thickness of the first electrode and the second electrode;
bonding the first electrode and the second electrode to a substrate; and
forming a passivation layer on the dielectric.

8. The method according to claim 7, wherein the metal sheet comprises aluminum.

9. The method according to claim 7, wherein the bridge has a width smaller than that of the first electrode and the second electrode.

10. The method according to claim 7, wherein the forming of the dielectric comprises an oxidation process that completely oxidizes the bridge.

11. The method according to claim 7, wherein the bonding of the first electrode and the second electrode to the substrate comprises using an adhesive to bond the first electrode and the second electrode to the substrate.

12. The method according to claim 7, wherein the forming of the dielectric comprises oxidizing the surfaces of the first electrode and the second electrode to the thickness of the first electrode and the second electrode after the first electrode and the second electrode are bonded to the substrate.

13. The method according to claim 7, wherein the forming of the dielectric comprises oxidizing the surfaces of the first electrode and the second electrode to the thickness of the first electrode and the second electrode before the first electrode and the second electrode are bonded to the substrate.

14. A method of manufacturing a plasma display panel, the method comprising:
pattering a metal sheet to form a first electrode, a second electrode, and a bridge connected to the first electrode and the second electrode;
oxidizing the first electrode and the second electrode to a thickness of the first electrode and the second electrode to form a dielectric surrounding the first electrode and the second electrode;
bonding the first electrode and the second electrode to a substrate; and
forming a passivation layer on the dielectric.

15. The method according to claim 14, wherein the metal sheet comprises aluminum.

16. The method according to claim 14, wherein the bridge has a width smaller than that of the first electrode and the second electrode.

17. The method according to claim 14, wherein the oxidizing the first electrode and the second electrode comprises completely oxidizing the bridge into an oxide.

18. The method according to claim 14, wherein the oxidizing the first electrode and the second electrode comprises oxidizing the first electrode and the second electrode to the thickness of the first electrode and the second electrode after the first electrode and the second electrode are bonded to the substrate.

19. The method according to claim 14, wherein the oxidizing the first electrode and the second electrode comprises oxidizing the first electrode and the second electrode to the thickness of the first electrode and the second electrode before the first electrode and the second electrode are bonded to the substrate.
